(19) United States
(12) Patent Application Publication
(10) Pub. No.: US 2025/0139498 A1
(43) Pub. Date: May 1, 2025

(54) DATA MANAGEMENT TO GUIDE AN UNSUPERVISED LABELING FOR CONTINUAL LEARNING IN EDGE DEVICES

(71) Applicant: Dell Products L.P., Round Rock, TX (US)

(72) Inventors: Isabella Costa Maia, São Paulo (BR); Karen Braga Enes, Belo Horizonte (BR); Karen Stéfany Martins, Belo Horizonte (BR); Luiz Fernando Sommaggio Coletta, Tupã (BR); Pablo Nascimento da Silva, Niterói (BR)

(21) Appl. No.: 18/496,017

(22) Filed: Oct. 27, 2023

(51) Int. Cl. G06N 20/00

(52) U.S. Cl. CPC G06N 20/00

(57) ABSTRACT

Continual learning and managing data related to continual learning in a computing network is disclosed. A central server trains and distributes a model to nodes in the computing network. When a model on a node detects a new domain, that node adapts its model to the new domain. Adapting the model includes requesting data from the new domain from other nodes. When the data from the other nodes is received, the model is retrained using the data from the other nodes and the unlabeled data at the node. The node may then label the unlabeled data.

### FIELD OF THE INVENTION

Embodiments of the present invention generally relate to continual learning. More particularly, at least some embodiments of the invention relate to systems, hardware, software, computer-readable media, and methods for continual learning in computing systems including edge systems and devices.

### BACKGROUND

Edge computing brings storage and processing capabilities closer to the devices that are generating and consuming data in the network. Advantageously, this makes data processing and data analysis faster. At the same time, edge computing promotes a decentralized approach to data processing and analysis. This decentralized approach may improve issues such as latency, network congestion and privacy.

Machine Learning (ML) models have been increasingly adopted as part of data-driven solutions, and many operate in both near and far edge scenarios. Continual Learning (CL), which often uses machine learning models and is also known as Lifelong Learning, Sequential Learning, or Incremental Learning, is a growing machine learning paradigm whose goal is to learn new tasks continuously and adaptively by adding knowledge to the model without sacrificing the previously acquired knowledge.

Unlike traditional architectures that focus on solving a single task at a time, continual learning relates to training a single model to perform many tasks, thereby using less computational power and model storage. Continual learning deals with the stability-plasticity dilemma, which focuses on accumulating knowledge (plasticity) without catastrophically forgetting prior knowledge (stability).

A single model capable of performing multiple tasks takes advantage of concepts such as forward and backward transfer. The knowledge earlier acquired is used in the new tasks, and the new task examples improve already learned ones, which avoid restarting the training process from zero and leads to better generalization. Continual learning is an intriguing alternative for models operating on the edge because of processing and storage constraints. Continual learning may also cope with the dynamic nature of new data because continuous learning allows machine learning models to adapt to changes in the data.

Generally, continual learning is divided in three scenarios: domain, task, and class incremental learning. In domain incremental learning, tasks have the same classes, but input distributions are different. In task incremental learning, the model is informed about which task needs to be performed, allowing models with task-specific components. In class incremental learning, models should be able to both solve each task seen so far and infer which class is being presented. All three scenarios assume that task boundaries are known during training, which can be a disadvantage when task identity is not available. Task agnostic continual learning focuses on this hard scenario where task boundaries are unknown during training.

Continual learning solutions are also divided into three main strategies: regularization, memory, and architecture based. Regularization based solutions avoid storing raw inputs from previous tasks. This is achieved by introducing an extra regularization term in the loss function and consolidating previous knowledge when learning on new data. On the other hand, memory based solutions, also known as rehearsal solutions, store samples from previous tasks in an ‘episodic memory’ (i.e., a small-sized memory buffer formed by previous important samples) and replay the stored tasks while learning a new task. Architecture based solutions, also known as parameter isolation, focus on the idea that different tasks should have their own set of isolated parameters. An architecture based approach freezes or adds a set of parameters to each task.

In some continuous learning problems, access to labeled data may be limited. For example, running continual learning on edge devices may require transferring data to a centralized service to obtain labels for supervised model training.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of continual learning in a computing environment;

FIG. 2 discloses aspects of a method for performing continuous learning in a computing environment;

FIG. 3 discloses aspects of training a model and serving edge nodes with the trained model;

FIG. 4 discloses aspects of adapting a model to a new domain;

FIG. 5 discloses aspects of unsupervised continual learning with enriched data;

FIG. 6 discloses aspects of aggregating data labeled by edge nodes according to their scores;

FIG. 7 discloses aspects of selecting an edge node with a highest performance regarding the data for a domain of interest;

FIG. 8 discloses aspects of labeling data at the edge node; and

FIG. 9 discloses aspects of a computing device, system, or entity.

### DETAILED DESCRIPTION OF SOME EXAMPLE EMBODIMENTS

Embodiments of the present invention generally relate to continual learning. More particularly, at least some embodiments of the invention relate to systems, hardware, software, computer-readable media, and methods for adapting models to new domains and automatically labeling data.

In one example, embodiments extend Adversarial Learning Networks (ALeN) in the context of domain incremental scenarios. ALeN is generally configured to update models by updating the weights of a feature extractor part of the network such that features for all past trained domains can be built. ALeN uses a small subset of labeled features to keep the predictions at a good accuracy level. However, ALeN does not ensure that the learned features are also effective for training without using a large amount of labeled data.

Embodiments of the invention provide a mechanism to perform continuous learning methods in or on edge computing environment, perform data management, and perform data labeling. In a system or environment with a large number of edge devices or edge nodes, (e.g., devices receiving real-time visual data from multiple cameras or data from other sources), each node is equipped with a machine learning model to continuously learn and generate predictions or inferences. To efficiently keep these models updated, embodiments of the invention share similar data among the edge nodes to improve their episodic memory (e.g., the memory used by the ALeN model to maintain the accuracies of the models), to help reduce or minimize catastrophic forgetting. A central server may act as a mediator in this process and may provide each edge node with data summarizations, scores, and edge locations.

In one example, embodiments of the invention operate in the following context: (i) the model learning may be performed on the edge device due to data gravity—it is too costly to send all the data to a central server or node for training; (ii) some data may be shared among the edge nodes using the central server (these are small amount of data); (iii) the system may provide, after some time, true labels for some instances during its own operation by using a manual labeling process or check.

Embodiments of the invention relate to domain-incremental learning scenarios. The data may arrive in batches and the batches have, in one example, the same classes but different data distributions. During training, only the current batch of data may be available and the current batch may pertain to an unlearned domain. However, embodiments of the invention ensure that model accuracy is maintained with respect to old tasks/domains. Embodiments of the invention further relate to a data management mechanism to share data across similar edge devices/systems to leverage unsupervised continuous learning accuracies.

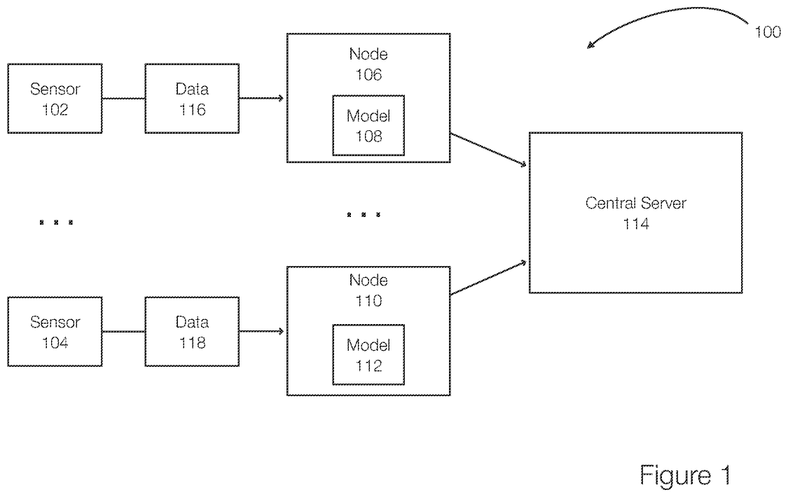

FIG. 1 discloses aspects on an environment in which continual learning is performed. FIG. 1 illustrates a computing environment or system 100. The system 100 may be representative of a system including near edge and/or far edge devices/systems. In this example, the system 100 include edge devices represented as nodes 106 and 110. Each of the nodes 106 and 110 may be a computing device (e.g., real or virtual) that includes processor(s), memory, networking hardware, and the like.

The nodes 106 and 110 are associated with, respectively, models 108 and 112. The node 106 is associated or linked with a sensor 102. In one example, the sensor 102 may be a camera configured to monitor or record a scene. The data 116 collected from the scene may be provided to the model 108. However, the data 116 may be subject to change. For example, the sensor 102 may monitor a location such as a street. The street, however, may undergo multiple scene variations for various reasons, such as weather conditions, rush hour traffic, or the like. Each of these changes may result in a new domain of the data 116.

The sensor 104 may also be a camera associated with data 118, which may be different from the data 116 (e.g., a different domain).

When the model 108 detects changes in the domain of the data 116 (e.g., a new data distribution), the model 108 is adapted to learn the new domain. This may include retraining the model 108 using new data. In one example, if the model 112 or node 110 has experience with the new domain of the data 116, data from the node 110 may be retrieved and used to retrain the model 108.

FIG. 1 thus illustrates a system 100 that may include a large number of edge devices (or nodes), where each node runs a model specifically configured for predictions in learned data domains. The central server 114 may be involved in various aspects of continuous learning, including model distribution, model updating, data collection, data distribution, or the like.

To deal with domain changes, embodiments of the invention relate to managing episodic memory for continuous learning performed in distributed edge scenarios and other computing networks or environments. A mechanism is disclosed that is configured to share data examples across similar environments that are being monitored by different edges or nodes in the network. This allows various models to up updated using a data that is enriched with more relevant data from other devices. This allows embodiments of the invention to compensate for storage constraints. Embodiments of the invention may also perform unsupervised labeling at the edges.

Embodiments of the invention can ensure that representative labeled data is more likely to be available when new domains appear. To maintain a model such that the model is efficient and robust to domain changes over time, it is useful to sample training data that adheres to the new domains. Embodiments of the invention provide autonomous ways to label and share data samples between edge nodes.

Embodiments of the invention are also able to identify domain changes and keep edge models updated without forgetting previous domains. A model may be configured to detect changes in the domain and adapt to a new domain distribution. Models can expand their knowledge over new domains and maintain accuracy with respect to old and new domains. This is achieved, at least in part, by sharing instances of an episodic memory across edge devices or nodes to improve the efficiency of the training process.

Embodiments of the invention relate to effectively managing the memory required to achieve continuous learning in a distributed computing environment. Embodiments of the invention relate to managing data for unsupervised continual learning being performed in distributed edge scenarios. Example distributed edge scenarios include, for example, a network of cameras in a building, park or road. Distributed edge scenarios more generally relate to a network that includes multiple edge devices or sensors and to using models to process the data generated at the edge devices.

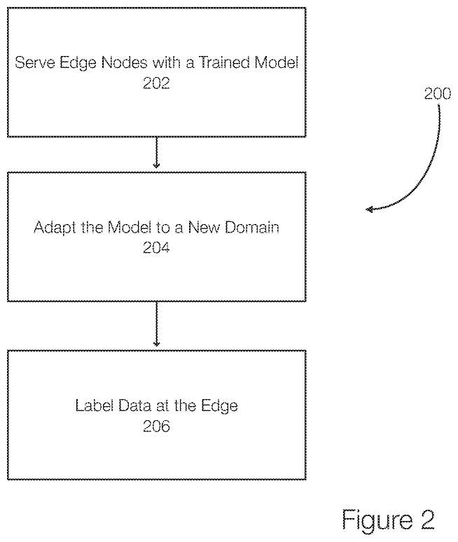

Embodiments of the invention may be achieved in phases. FIG. 2 discloses aspects of example phases for managing data in performing continuous learning in a distributed computing system. The first phase of a method 200 includes serving 202 edge nodes with a trained model.

More specifically, a single model M (e.g., a MLP, CNN, NN, etc.) may be trained (e.g., at a central server), with an initial labeled dataset L containing data for all previously \hat{z} known domains D=[D¹, D², . . . , D^{\hat{z}}]. Next, the edges devices (e.g., nodes) E₁, E₂, . . . , Eₖ are initialized with the model M, domain summarizations I=[I¹, I² . . . , I^{\hat{z}}], and an episodic memory (rehearsal) R=[R¹, R², . . . , R^{\hat{z}}]. The episodic memory or rehearsal R includes a predefined number of instances of each domain in D. Then, a table T on a central server is initialized. The table T stores information of all edge devices, their locations, data summarizations, and other information.

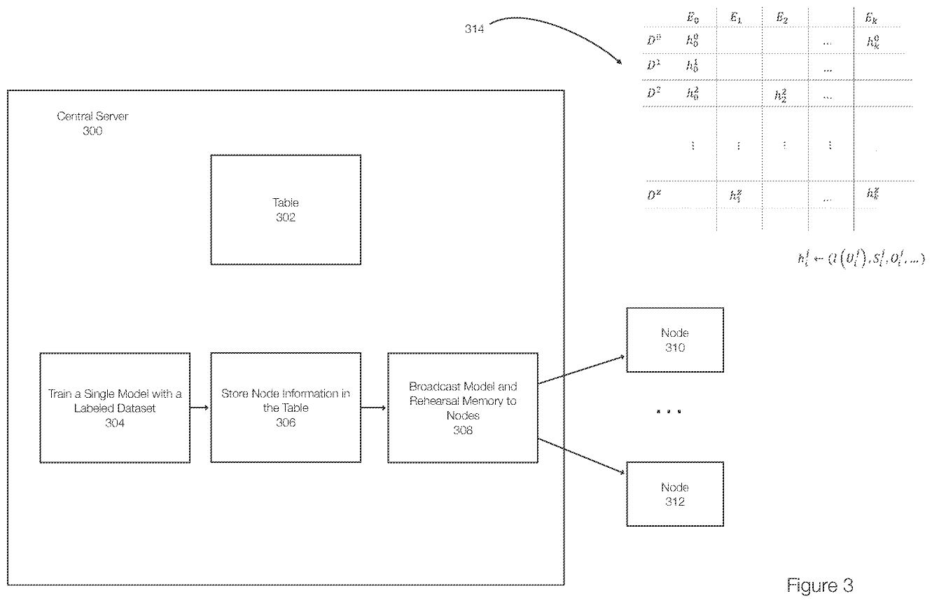

FIG. 3 discloses additional aspects of serving edge nodes with a model or of initializing edge nodes of a computing system to perform continuous learning in accordance with embodiments of the invention. The model may be based on ALeN architecture, which is described in Ambastha and Yun 2023 “Adversarial Learning Networks: Source-free Unsupervised Domain Incremental Learning”, which is incorporated by reference in its entirety.

Initially, a central server 300 may train 304 a single model M with a labeled dataset L. More generally, the model trained by the central server 300 should be, in one example, a general machine learning model, thereby ensuring that all nodes start with a reasonable and general machine learning model. The trained model can also be used as a starting point for any new edge node entering or added to the computing system.

To perform the training 304, a labeled dataset L containing data for a set of pre-defined 2 known domains D=[D¹, D², . . . , D^{\hat{z}}] is selected. After the model is trained, the model is broadcast 308 to each of the nodes, represented by the nodes 310 and 312 (e.g., nodes [E₁, E₂, . . . , Eₖ], where k is the number of edge devices of nodes. Each edge node Eᵢ is initialized with model M and an episodic memory (rehearsal) R=[R¹, R², . . . , R^{\hat{z}}] containing b instances of each domain. The number of instances b may be a pre-defined value that may be selected and calibrated according to the available resources in the edge node.

Prior to broadcasting 308 the model (or concurrently), edge device or node information may be stored 306 in a table 302 at the central server 300. Stated differently, the table 300 is initialized with information about the nodes 310 and 312. The table 302, an example of which is illustrated at 314, may be used to annotate or store historical information on edge node operations, including, for each edge node, its known domains, the training order of the domains, data summarizations, performance scores related to the rehearsal data, statistics, and the like.

When the node 310 (e.g., edge node Eᵢ) is initialized, the node 310 is initialized with its model Mᵢ, a set of previously learned domains Dᵢ=[Dᵢ¹, Dᵢ², . . . , Dᵢ^{z}], domain summarizations Iᵢ=[Iᵢ¹, Iᵢ², . . . , Iᵢ^{z}], and episodic memory Rᵢ=[Rᵢ¹, Rᵢ², . . . , Rᵢ^{z}]. The table 302 (T), in one example, is stored at the central server 300. Each column of the table 302 (or 314) represents a specific node Eᵢ and each row represents a specific edge domain Dᵢ^{j}. The historical information is stored in each cell hᵢ^{j}←(I(Uᵢ^{j}), Sᵢ^{j}, Oᵢ^{j}, . . . ), where I is a data summarization function, Uᵢ^{j} represent the unlabeled data of the domain, Sᵢ^{j} is the score of the rehearsal memory, and Oᵢ^{j} is the insertion order. This tuple may also be configured to include additional information including summarization information.

To generate the data summarization I, different metrics such as mean, median and standard deviation of each feature in data Uᵢ can be generated or applied. The table 302 may be implemented as a sparse matrix or table.

After the first phase 202, the second phase beings. The second phase of the method 200 includes adapting 204 the model to a new domain. This is typically performed when a node has detected a new domain and is often performed at specific nodes (e.g., those that have detected a new domain). Thus, adapting the model to a new domain may be performed after the model M has been operating at the nodes in the distributed system.

In one example, an edge node Eᵢ is associated with or includes a model Mᵢ, a set of previously learned domains Dᵢ [Dᵢ¹, Dᵢ², . . . , Dᵢ^{\hat{z}}], domain summarizations Iᵢ=[Iᵢ¹, Iᵢ², . . . Iᵢ^{\hat{z}}] and episodic memory Rᵢ=[Rᵢ¹, Rᵢ², . . . , Rᵢ^{\hat{z}}]. When edge node Eᵢ receives new unlabeled data Uᵢ the edge node Eᵢ may calculate its summarization and verify whether the data Uᵢ belongs to a new domain Dᵢ^{\hat{z}+1} by comparing the summarization of the data Uᵢ to the already known data summarizations contained in Iᵢ.

If Uᵢ belongs to a new domain, Dᵢ^{\hat{z}+1}, the edge node Eᵢ may communicate with the central server to determine whether there are other edge nodes that have a data summarization that is similar to the data summarization Iᵢ^{\hat{z}+1}. This information may be maintained in the table of the central server. If a similar summarization is present in the central server's table, the edge node Eᵢ may receive the identifiers of the other nodes that may have similar data.

If multiple nodes have the data needed by the node Eᵢ, a selection process may be performed to identify the nodes that contain or have the best data needed to train the model Mᵢ of the edge node Eᵢ for the new domain.

Once a node having the needed data is selected, data (or data samples) are obtained from the selected node's episodic memory to increase or augment Rᵢ of the requesting node with data samples corresponding to the new domain Dᵢ^{\hat{z}+1}. Thus, the model of the requesting node is adapted to the new domain without forgetting previously learned domains using data from other nodes in the system that may have already learned the new domain.

More specifically, adapting 204 the model for a new domain may also include training an unsupervised continual learning model Mᵢ to learn the new domain Dᵢ^{\hat{z}+1} using Uᵢ and the current episodic memory Rᵢ (this memory is used to avoid catastrophic forgetting of previous domains and may or may not contain the data from the new domain depending on what was found in Table T of the central server.

If, however, the new data Uᵢ belongs to a domain already included in Dᵢ, labels may be predicted for the data Uᵢ using the current model Mᵢ.

Adapting 204 the model for a new domain relates to memory management for continual learning operating in distributed nodes or other edge devices. When adapting the model for a new domain, the node, whose model is being updated, may be in communication with the central server to access the table.

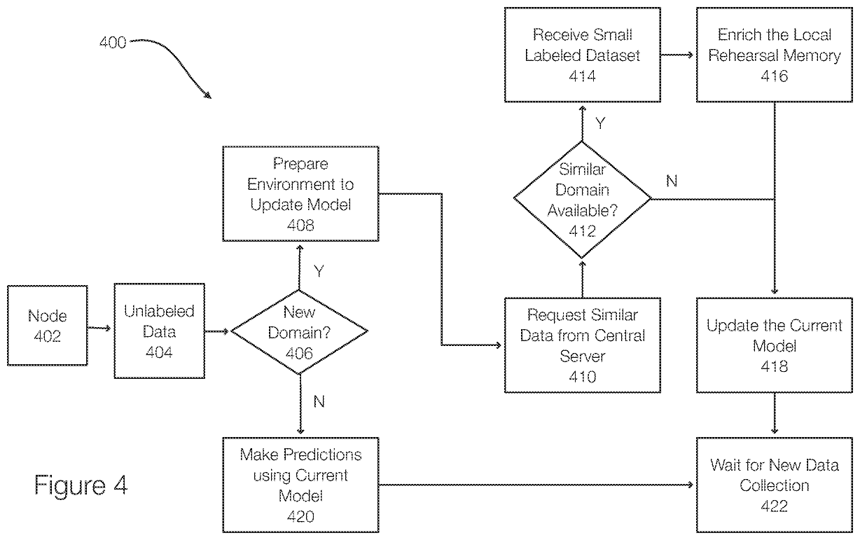

FIG. 4 discloses additional aspects of adapting 204 a model to a new domain. After a model is deployed to an edge node, the edge node monitors the stream of data to determine whether the domain is changing. When a change in the domain is detected, the process of adapting the model may be initiated and is illustrated in the method 400.

In the method 400, the node 402 starts collecting unlabeled data 404 (Uᵢ^{j}) from the data stream and compares a distribution of the acquired unlabeled data 404 with distributions that the node 402 has already seen and which are stored in the rehearsal data. More specifically, the unlabeled data can be summarized and compared to the summarizations of the domains already learned. If no change in the data distributions based on the summarization comparisons is observed and a new domain is not present (N at 406), the current model is used to make 420 predictions. If a change in the domain is determined (Y at 406), the environment (e.g., node 402) is prepared 408 to update the model such that the model can generate accurate predictions regarding the unlabeled data 404.

Because labeled data from the domain is not necessarily available or is scarce, embodiments of the invention rely on other nodes that may have already seen the domain that is new to the node 402. Even if the amount of this data is small, the data, which will be retrieved from other nodes, will improve the rehearsal memory of the requesting node 402. The rehearsal memory is used alongside the unlabeled data to train the model in an unsupervised manner and allows the model to be adapted to the new domain without forgetting previously learned domains.

Thus, if the domain is new (Y at 406), the environment is prepared 408 for updating the model and similar data is requested 410, by the requesting node 402, from the central server. More specifically, the node 402 is determining whether the central server is aware of data that is similar to the unlabeled data 404. The central server will access its table to determine 412 whether data from the new domain or a sufficiently similar domain is available at other nodes. For example, the central server may compare a summarization of the unlabeled data 404 to summarizations stored in its table to identify a similar domain and nodes that may have learned the domain or a similar domain. The central server may also store the data that is being requested, for example in the table or in a cache or other storage.

If a similar domain is available (Y at 412), the node 402 receives 414 a labeled data set Ūᵢ^{j} for the Uᵢ^{j} from the central server or from one of the nodes identified by the central server. The node then enriches 416 the local rehearsal memory Rᵢ of the node 402 with the labeled set Ūᵢ^{j}.

Next, the model 418 of the node 402 is updated (e.g., trained or retrained) using the updated rehearsal data Rᵢ and the unlabeled data 404. In the event that no similar data is found at the server, the model is updated 418 (in an unsupervised manner in one example) using or based on the unlabeled data 404. The node 402 then waits 422 for a new data collection or waits until a new domain is detected, at which point the model is again adapted to the new domain in a similar manner.

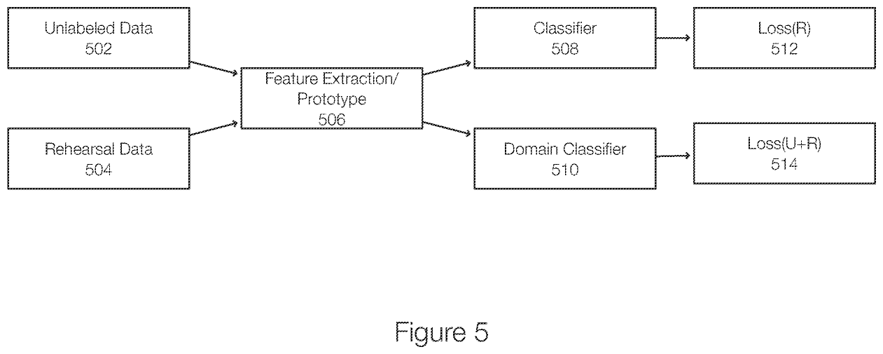

FIG. 5 discloses aspects of unsupervised continual learning with enriched data. FIG. 5 illustrates an unsupervised continual learning method using the unlabeled data 502 and the rehearsal data 504, which has been enriched with labeled data received from the central server or other nodes. The unlabeled data 502 and the rehearsal data 504 are used together to improve the feature extraction/prototyping 506. The rehearsal data 504 helps ensure that the predictions are being performed correctly. Thus, the loss 512 reflects a loss of the classifier 508 for the rehearsal data 504 and the loss 514 reflects a loss of a domain classifier 510 for both the unlabeled data 502 and the rehearsal data 504.

When a node requests data from the central server that may be related to a new domain with respect to the requesting node, the central server may aggregate data from different nodes according to a score. Each collection of data stored in the central server includes score information. The score reflects a quality of the data for training a given model.

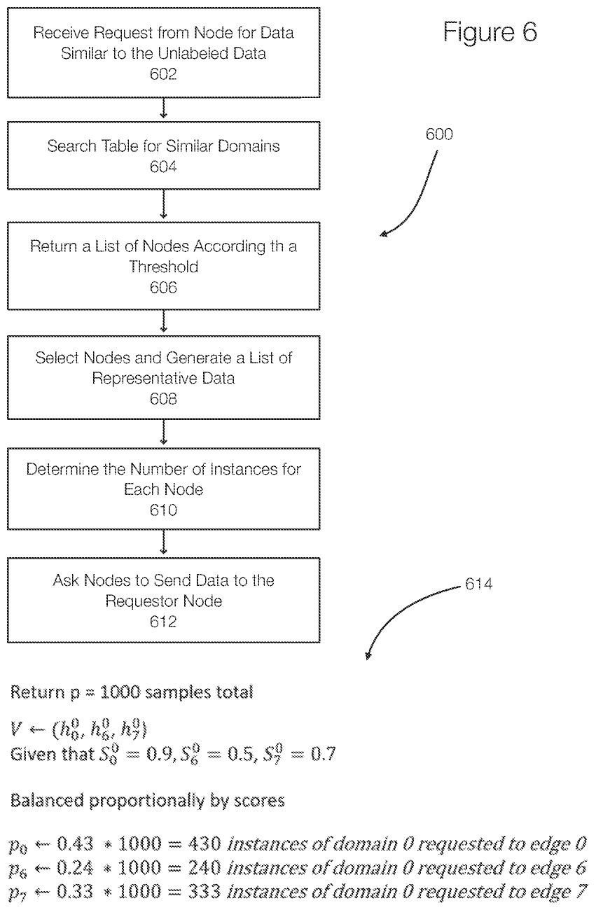

FIG. 6 discloses aspects of aggregating data labeled by edge nodes according to these scores. As previously discussed, a request is sent to the central server when a new domain is identified such that the rehearsal memory used for training can be enhanced with labeled data from other nodes or used data stored at the central server.

In the method 600, the central data receives 602 a request from a requesting node for labeled data of data domains similar to the domain of the unlabeled data Uᵢ^{j} domain that is currently present at the requesting node. This may include sending a summarization of the target (the newly detected) domain I(Uᵢ^{j}) to the central server. The summarization may be a function that extracts the data distribution of each feature in the dataset or may summarize the data in a different manner. The summarization is performed, in one example, to avoid sending raw data to the central server every time a comparison between domains is needed.

The central server, upon receiving the request, searches 604 the table for similar domains. The central server may compare the summarization received from the requesting node with summarizations stored in the table. The central server may generate or return 606 a list of nodes whose data satisfies a threshold value. For example, summarizations that are within a threshold distance of the summarization received from the requesting node may be included in the list. For the nodes that are on the list, their representative data may also be identified.

Embodiments of the invention are configured to return good data or data that is more representative of the domain such that the model can be trained more effectively using the scores that have been generated for the data. The data returned to the requesting node may include the data that was also used to train other nodes. In one example, the number of instances of data for each node in the list is identified 610 and the corresponding nodes are asked 612 to send their representative data to the requesting node. In one example, the central server may build a cache to optimize performance of the system.

For example, the central server may determine to send 1000 samples or instances of the data. The data is selected from multiple nodes, using the scores, and returned as illustrated in the summary 614 in FIG. 6. The summary 614 illustrates that 430 instances were requested from a first node, 240 instances from a second node, and 333 instances from a third node. These instances are provided to the requesting node and used to update the rehearsal data. These instances from these other nodes are labeled instances of data in one example.

When selecting 608 the nodes or generating the list of nodes that may have data responsive to the request from the requesting node, nodes (or their data summarizations) that satisfy a threshold may be identified. In one example, this list may be further restrained to increase the odds of benefitting from backward and forward transfer when learning the domain.

For example, a requesting node may be associated with a corresponding set of current learned distributions Dᵢ. Embodiments of the invention may select a number (e.g., num_e) edge nodes having learned a distribution of interest d*, which is the new domain to the requesting node. The nodes that have maximum intersection between their history of learned distributions and Dᵢ (domain score ds—the number of intersecting learned domains between the histories of the nodes) are prioritized. In one example, using only data from nodes known to provide reasonable model performance, chances of benefitting from backward and forward transfer is improved. Further, embodiments aim to prioritize the choice of nodes that achieve the highest performance (performance score ps—the model's performance when evaluated with data corresponding to the domain of interest) in the event of a tie.

When evaluating the table, the central server may identify a subset of the network containing N edge nodes that have already learned the domain of interest d* and have achieved a performance greater than th.

In this example, [symbol] is an array containing the arrays of learned domains from all other edge nodes, such that len( [symbol] )=N and d*∈ [symbol] [i], ∀i=1, . . . , N, [symbol] [i] being the set of previously learned domains from one of the N selected edge nodes.

Dᵢ is the array containing all the historical distributions of the node Eᵢ such that d*∉ Dᵢ, num_e is a maximum desired number of edge nodes to be selected by Eᵢ, and ps is the performance score vector containing a performance metric value for each of the N edge nodes.

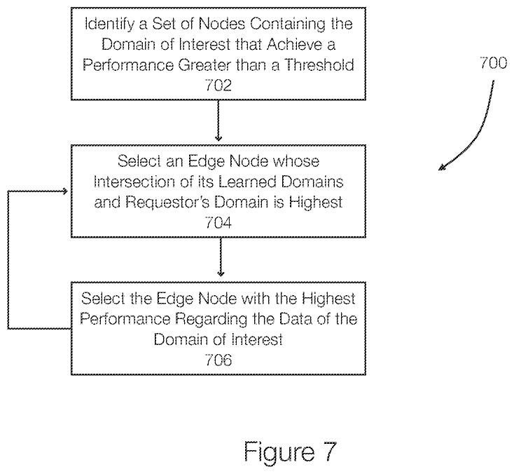

This is further illustrated in FIG. 7, which discloses aspects of selecting an edge node with a highest performance regarding the data for a domain of interest. The method 700 includes identifying 702 a set of nodes (e.g., N nodes) that include or that have learned a domain of interest and that achieve a performance greater than a threshold performance. The edge node whose intersection of its learned domain with the learned domains (Dᵢ) of the requesting node is highest is selected 704. If there is a tie, the edge node with the highest performance regarding the data of the domain of interest is selected 706. This process is repeated until a specified number of nodes are selected or all available nodes have been added.

For example, a requesting edge node may have knowledge over the domains {1, 2, 3, 4, 5, 6} and the nodes 0, 1, 2 have knowledge over domains {2, 3, 6, 7}, {1, 2, 4}, {1, 2, 3, 4}, respectively. A performance score is associated to each of the edges 0, 1, 2 and the method may select num_e=2 nodes with the highest domain intersection and best performance score. The algorithm computes the domain score of each of the edges and, even if edges 0 and 1 achieve a similar domain score, the node 1 is selected because of its higher performance score. Thus, the model of the requesting node is adapted 204 to the new domain.

Returning to FIG. 2, the method 200 performs a third phase that may include labeling 206 data at the node or at the edge. Whenever a new model Mᵢ is available, predictions are made using instances from the current domain Uᵢ (no labels available). Instances from Uᵢ are sampled according to the predictions. The episodic memory Rᵢ is updated with labeled instances from the past domain. A score S of the predictions on the rehearsal memory Rᵢ is determined and sent to the central server.

Embodiments of the invention thus relate to a pipeline to allow unsupervised Continual Learning in edge devices or nodes that adapts to new domains while maintaining previous knowledge. Data management is provided to guide an unsupervised labeling for Continual Learning in the edge devices. A score metric for intelligent selection of representative instances to update episodic memory is generated. Data is shared in a manner that considers a models performance and the similarity among the previously identified domains of the edge nodes.

More specifically, labeling 206 data at the edge relates to the process of selecting and labeling good data for training purposes. The process of labeling can be used for two different tasks. The first task is to help other edge nodes with similar data improve their models. The second task is to calculate the score of the data and provide assurances that the unsupervised process is operating correctly.

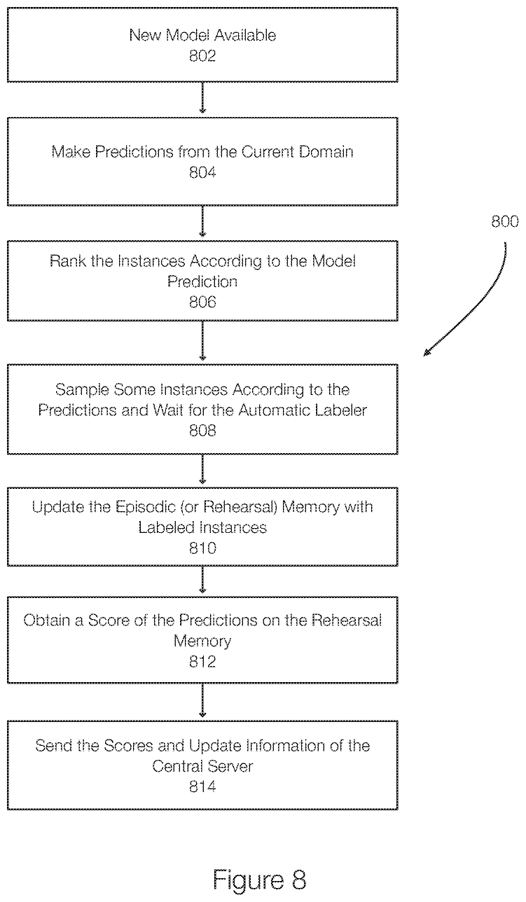

FIG. 8 discloses aspects of labeling data at the edge node. In the method 800, the process of labeling data often begins when a new model Mᵢ is trained in the edge node and available 802. This may be the case after updating the model. Next, the unlabeled data Uᵢ^{j} used in the training is obtained and predictions are made 804 using the model Mᵢ(Uᵢ^{j}). This process will result in a predictive score of each sample, i.e., a predictive score in this context means the confidence the model has in the prediction. These instances are ranked 806 according to the confidence score. This rank will help with the automatic labeler or oracle, whatever is available for returning the correct label.

Some of the instances are sampled 808 and correct labeling is performed. For example, labeling the top ranked instances may include waiting for future inputs of the system (e.g., the system provides the real label after the input of the operator, and this information can be used as the true label) or send the data to a manual annotator. In case none of this is available, the model's output score may be used as a true labeler, making those predictions with high probability being considered correct for the model in the edge node.

When this is completed, the labeled instanced are used to update 810 the episodic memory with the labeled instances. This improves the rehearsal memory of the current node.

Next, a score of the predictions is obtained 812. Obtaining the score in effect determines how well (e.g., model accuracy) the model was performing on the trained data Uᵢ^{j} that is going to be used as rehearsal data for the next training iterations. The score may also help in determining whether the training data can help improve the training of other edge nodes. Finally, the scores of the current data are provided or sent 814 to the central server and stored in the central server's table such that other nodes can know how good the edge node data is and ask for parts of it to improve their rehearsal memory if necessary.

Embodiments of the invention manage data to guide an unsupervised labeling for continuous learning in edge devices or nodes and can be applied in many scenarios. For instance, embodiments of the invention may be used in a scenario where there are many edge devices and each one is connected to surveillance camera responsible for covering a specific location from an angle (e.g., pedestrian, cars, bicycles, etc.). Because this scenario is constantly changing due to weather conditions, rush hours and lighting, a machine learning model uploaded in the camera (or other node receiving the camera's data) is prone to errors. To avoid domain changes errors, the model should recognize that the data belongs to a new domain and automatically learn how to predict on the new domain without forgetting previous ones. Another example is a model running on different factories to predict when a device will stop working. Considering that a factory undergoes regular maintenance and devices can be replaced, the model also needs to be updated to recognize the new domain and the model can be retrained for the new domain by leveraging data from other factories.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, machine learning operations, model updating and model adapting operations, labeling operations, and the like. More generally, the scope of the invention embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data storage and protection functionality for one or more clients. Another example of a cloud computing environment is one in which services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers, and clients, for example, may likewise take the form of software, physical machines, containers, or virtual machines (VM), though no particular component implementation is required for any embodiment.

As used herein, the term ‘data’ is intended to be broad in scope. Example embodiments of the invention are applicable to any system capable of storing and handling various types of objects, in analog, digital, or other form.

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: serving a machine learning model to nodes in a computing system, detecting a new domain of data at a first node included in the nodes, the first node associated with a first model, and adapting the first model to learn the new domain without forgetting previously learned domains, wherein adapting the first model includes retrieving sample data from other nodes that is similar to data of the new domain and training the first model with the sample data.

Embodiment 2. The method of embodiment 1, further comprising training the machine learning model at a central server prior to serving the machine learning model to the nodes, wherein the model served to the nodes is associated with learned domains, domain summarizations, and a rehearsal data.

Embodiment 3. The method of embodiment 1 and/or 2, further comprising storing information for each of the nodes in a table at the central server, the information including a summarization of unlabeled data, a score of the rehearsal data, and an insertion order for domains subsequently learned.

Embodiment 4. The method of embodiment 1, 2, and/or 3, further comprising receiving a request fora new domain at the central server, the request including a summarization of data of the new domain.

Embodiment 5. The method of embodiment 1, 2, 3, and/or 4, further comprising determining whether other nodes have learned the new domain by comparing the summarization data with summarization data of the other nodes stored in the table.

Embodiment 6. The method of embodiment 1, 2, 3, 4, and/or 5, further comprising generating a labeled dataset including labeled data from the new domain from some of the other nodes.

Embodiment 7. The method of embodiment 1, 2, 3, 4, 5, and/or 6, further comprising training the first model using the labeled dataset and the data from the new domain at the first node.

Embodiment 8. The method of embodiment 1, 2, 3, 4, 5, 6, and/or 7, further comprising selecting nodes from the other nodes to acquire the labeled dataset by identifying a set of nodes containing the new domain that achieve a performance greater than a threshold and selecting the nodes whose intersection of its learned domains and learned domains of the first node are highest.

Embodiment 9. The method of embodiment 1, 2, 3, 4, 5, 6, 7, and/or 8, further comprising labeling data at the first node using the updated first model.

Embodiment 10. The method of embodiment 1, 2, 3, 4, 5, 6, 7, 8, and/or 9, further comprising sending scores of the updated first model to the central server.

Embodiment 11. A non-transitory storage medium having stored therein instructions that are executable by one or more hardware processors to perform operations comprising the operations of any one or more of embodiments 1-10.

Embodiment 12. A system, comprising hardware and/or software, operable to perform any of the operations, methods, or processes, or any portion of any of these, disclosed herein.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

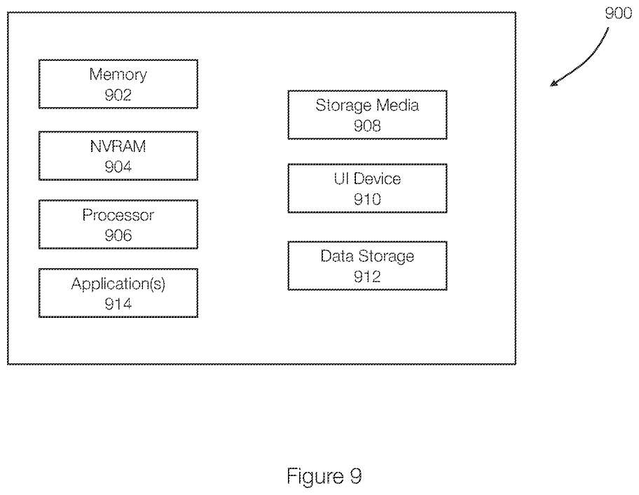

With reference briefly now to FIG. 9, any one or more of the entities disclosed, or implied, by the Figures and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein. The device 900 may represent a node or edge device, a central server, a continuous learning environment or portions thereof, or the like.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
serving a machine learning model to nodes in a computing system;
detecting a new domain of data at a first node included in the nodes, the first node associated with a first model; and
adapting the first model to learn the new domain without forgetting previously learned domains, wherein adapting the first model includes retrieving sample data from other nodes that is similar to data of the new domain and training the first model with the sample data.

2. The method of claim 1, further comprising training the machine learning model at a central server prior to serving the machine learning model to the nodes, wherein the model served to the nodes is associated with learned domains, domain summarizations, and a rehearsal data.

3. The method of claim 2, further comprising storing information for each of the nodes in a table at the central server, the information including a summarization of unlabeled data, a score of the rehearsal data, and an insertion order for domains subsequently learned.

4. The method of claim 1, further comprising receiving a request for a new domain at the central server, the request including a summarization of data of the new domain.

5. The method of claim 4, further comprising determining whether other nodes have learned the new domain by comparing the summarization data with summarization data of the other nodes stored in the table.

6. The method of claim 5, further comprising generating a labeled dataset including labeled data from the new domain from some of the other nodes.

7. The method of claim 6, further comprising training the first model using the labeled dataset and the data from the new domain at the first node.

8. The method of claim 7, further comprising selecting nodes from the other nodes to acquire the labeled dataset by identifying a set of nodes containing the new domain that achieve a performance greater than a threshold and selecting the nodes whose intersection of its learned domains and learned domains of the first node are highest.

9. The method of claim 1, further comprising labeling data at the first node using the updated first model.

10. The method of claim 9, further comprising sending scores of the updated first model to the central server.

11. A non-transitory storage medium having stored therein instructions that are executable by one or more hardware processors to perform operations comprising:
serving a machine learning model to nodes in a computing system;
detecting a new domain of data at a first node included in the nodes, the first node associated with a first model; and
adapting the first model to learn the new domain without forgetting previously learned domains, wherein adapting the first model includes retrieving sample data from other nodes that is similar to data of the new domain and training the first model with the sample data.

12. The non-transitory storage of claim 11, further comprising training the machine learning model at a central server prior to serving the machine learning model to the nodes, wherein the model served to the nodes is associated with learned domains, domain summarizations, and a rehearsal data.

13. The non-transitory storage of claim 12, further comprising storing information for each of the nodes in a table at the central server, the information including a summarization of unlabeled data, a score of the rehearsal data, and an insertion order for domains subsequently learned.

14. The non-transitory storage of claim 11, further comprising receiving a request for a new domain at the central server, the request including a summarization of data of the new domain.

15. The non-transitory storage of claim 14, further comprising determining whether other nodes have learned the new domain by comparing the summarization data with summarization data of the other nodes stored in the table.

16. The non-transitory storage of claim 15, further comprising generating a labeled dataset including labeled data from the new domain from some of the other nodes.

17. The non-transitory storage of claim 16, further comprising training the first model using the labeled dataset and the data from the new domain at the first node.

18. The non-transitory storage of claim 17, further comprising selecting nodes from the other nodes to acquire the labeled dataset by identifying a set of nodes containing the new domain that achieve a performance greater than a threshold and selecting the nodes whose intersection of its learned domains and learned domains of the first node are highest.

19. The non-transitory storage of claim 11, further comprising labeling data at the first node using the updated first model.

20. The non-transitory storage of claim 19, further comprising sending scores of the updated first model to the central server.
